(19) United States
(12) Patent Application Publication
(10) Pub. No.: US 2026/0339865 A1
(43) Pub. Date: Oct. 29, 2026

(54) INTERMEDIATED INTERACTIONS BETWEEN AN AI-BASED APPLICATION AND REMOTE DATA SOURCES

(71) Applicant: PAYPAL, INC., San Jose, CA (US)

(72) Inventors: Sasikala Somasundaram, Chennai (IN); Andrea Nicole Lown, Toronto (CA)

(21) Appl. No.: 19/193,566

(22) Filed: Apr. 29, 2025

(51) Int. Cl. G06F 13/38

(52) U.S. Cl. CPC G06F 13/38; G06F 2213/40

(57) ABSTRACT

A method for intermediated interactions between a smart assistant and remote data sources includes receiving, by an intermediary device, a first request from a user device, wherein the first request includes parameters. The intermediary device selects digital records that include predefined attributes satisfying the parameters, generates a response dataset including metadata of the digital records, transmits to the user device the response dataset for presenting the metadata of the digital records, receives from the user device a second request including an identifier associated with the response dataset, facilitates an interaction between the user device and a remote data source from the remote data sources in response to the second request.

### TECHNICAL FIELD

The present disclosure relates to data transmission between electronic devices and, more particularly, to intermediated interactions between an AI-based application and remote data sources.

### BACKGROUND

Computing devices, such as smartphones, may run one or more AI-based applications, such as smart assistants. Smart assistants may use artificial intelligence (AI) and/or natural language processing (NLP) to understand and respond to voice commands, text inputs, and/or other inputs. A smart assistant can be used to find and recommend information to users. For example, a user can ask their smart assistant to “what's the latest news on my favorite sports team” and receive a relevant response and/or recommendations for sports team apparel.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a block diagram of an example intermediated interaction system, in accordance with one or more embodiments.

FIG. 2 is an example partial user interface for an AI-based application, in accordance with one or more embodiments.

FIG. 3 is a process diagram of an example process for intermediated interactions between two computing devices, in accordance with one or more embodiments.

FIG. 4 is a process diagram of an example process for intermediated interactions between two computing devices, in accordance with one or more embodiments.

FIG. 5 is a flow diagram of an example process for intermediating interactions between two computing devices, in accordance with one or more embodiments.

FIG. 6 is a block diagram of an example computing device, in accordance with one or more embodiments.

### DETAILED DESCRIPTION

AI-based applications, such as smart assistants, can generate useful outputs but often lack direct integration with remote data sources that allow users to act on the outputs. This gap forces users to manually search for items, services, or other information output by smart assistants, leading to disjointed user experiences, inefficiencies, and lost engagement opportunities.

AI-based applications often rely on broad, pre-trained knowledge that lacks real-time data, such as availability, personalized options, and transactional capabilities. Without a structured intermediary, integrating AI-generated content with remote data sources requires complex, case-by-case integrations that can be difficult to scale. Embodiments of the present disclosure address the lack of integration by introducing an intermediary device, which provides a centralized access point for retrieving structured, up-to-date digital records from multiple remote data sources.

By integrating AI-generated content with real-time, structured data from remote data sources, embodiments of the present disclosure can transform static outputs into interactive, actionable user experiences. Facilitating user interactions with remote data sources within the AI-based application increases user engagement with the application.

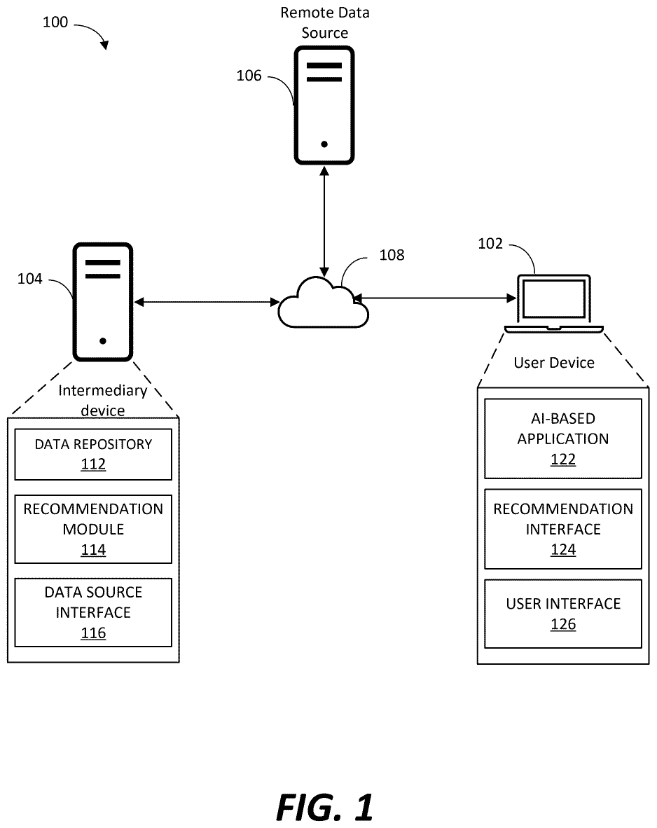

Referring now to the drawings, wherein like numerals refer to the same or similar features in the various figures, FIG. 1 is a block diagram of an example intermediated interaction system 100, in accordance with one or more embodiments.

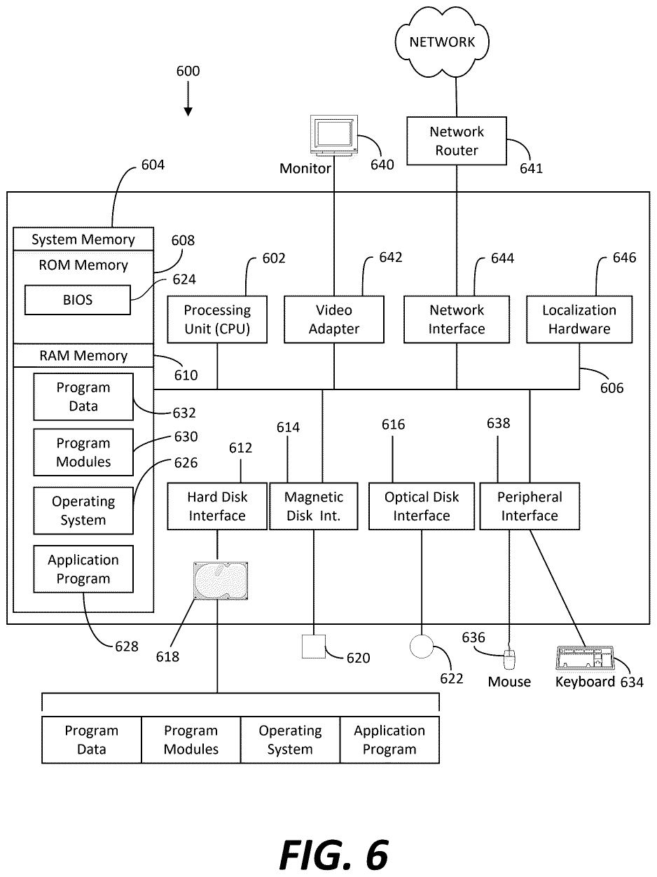

The system 100 may include a user device 102 associated with a user. The user device 102 may be a computing device such as a laptop computer, desktop computer, tablet, smartphone, smartwatch, or any other electronic device, such as a computing device having some or all of the components described with respect to FIG. 6. The user device 102 may be in communication with an intermediary device 104 and/or remote data source 106 via a network 108. The user device 102 may include an AI-based application 122, recommendation interface 124, and/or a user interface 126.

The AI-based application 122 includes software that integrates AI to enhance user interactions through features such as recommendations, automation, or content generation. The application 122 can take various forms, including native applications, web applications, operating system features, and/or the like. The application 122 may be or include smart assistants, chatbots, visual recognition tools, automated decision-making systems, and/or the like. The application 122 may include and/or utilize artificial intelligence models, such as large language models (LLMs), neural networks, and/or any other suitable AI program, to generate content, make predictions, deliver proactive assistance, and/or the like. For instance, an AI-based application 122 may be an AI-powered item discovery assistant configured to suggest relevant items based on LLM-generated content.

The recommendation interface 124 enables bidirectional communication between the AI-based application 122 and the intermediary device 104. The recommendation interface 124 may utilize APIs (e.g., RESTful or GraphQL) to standardize request and/or response formats, allowing the AI-based application 122 to send requests to the intermediary device 104, which then interprets, modifies, and/or forwards the requests to the remote data source 106.

The user interface 126 enables the user to interact with the user device 102. With the user interface 126, the user can provide data to and/or receive data from the intermediary device 104 and/or the remote data source 106. The user interface 126 may be in any suitable format such as one or more web pages, mobile application, software application, or other software, firmware, or other computer instructions. The user interface 126 may accept input in a variety of different formats, such as through speech recognition, text input, or other means, as embodiments are not limited in this respect.

The intermediary device 104 is a computing device configured to intermediate interactions between the AI-based application 122 and one or more remote data sources. The intermediary device 104 may be one or more physical and/or virtual servers and may include components described with respect to FIG. 6. The intermediary device 104 may be configured to maintain user accounts, generate session keys, validate digital signatures, etc. In some embodiments, the intermediary device 104 may be or be associated with a computing action request processor with which the user has an account to process data, requests, payments, and/or the like. The intermediary device 104 may host (or may be in network communication with another server that hosts) a data repository 112, recommendation module 114, and/or a data resource interface 116.

The data repository 112 may be a storage location that holds a collection of data records, which may include structured and unstructured data, such as documents, images, videos, and databases. The data repository 112 may maintain user-related information, such as session data, preference settings, account details, historical interaction records, or any other digital records. The data repository 112 may be or include a persistent and/or transient data store that helps the intermediary device 104 to intermediate interactions between the AI-based application 122 and the remote data source 106, for example, by retaining user-specific insights across sessions. The data repository 112 may be or include relational databases (e.g., PostgreSQL, MySQL) for structured, queryable data and/or NoSQL databases (e.g., MongoDB, Redis) for flexible, schema-less storage (e.g., of user preferences and real-time session states).

The recommendation module 114 may be configured to aggregate and structure information from one or more remote data sources (e.g., remote data source 106) based on a request from the AI-based application 122. For example, if a user prompts a smart assistant for a restaurant recommendation, the smart assistant may provide an AI-generated output including a restaurant name and then send a request to the recommendation module 114 for recommendations from remote data sources based on the restaurant name; if a user prompts a smart assistant asking for assistance with a flat tire, the smart assistant may provide an AI-generated output including a mechanic name and then send a request to the recommendation module 114 for recommendations from remote data sources based on the mechanic name; if a user prompts a smart assistant asking to modify the user's account information, the smart assistant may provide an AI-generated output including directions to access part of the application 122 where account information may be modified and then send a request to the recommendation module 114 for recommendations from remote data sources based on the directions.

The request from the AI-based application 122 may include at least part of the AI-generated output. The recommendation module 114 may use the request from the application 122 to generate requests to retrieve data from relevant data sources, local and/or remote. The recommendation module 114 may provide the requests to the corresponding data sources (e.g., merchants, aggregators, search engines) via a data source interface 116 (e.g., APIs, data feeds) that may include an integration between the data source and the recommendation module 114. This way, the recommendation module 114 can dynamically query remote data sources to retrieve, for example, a list of restaurants (including the restaurant recommended by the application 122 along with similar restaurants), real-time availability, and location-based discounts, which can be presented to the user with the smart assistant's recommendation.

The recommendation module 114 may filter and/or rank results from the data sources in response to a request. The module 114 may rank results based on user affinity data, which may include metrics such as click-through rates, past selections, dwell time, and conversion outcomes. User affinity data may be used to construct implicit feedback models that assign weights to items based on their likelihood of being relevant to similar users. The module 114 may also rank results based on content-based attributes, which may include product descriptions, style tags, category matches, and metadata quality. This way, the module 114 may evaluate how closely a result's structured attributes align with the request parameters. The module 114 may also rank results based on natural language processing techniques, such as generating semantic similarity scores between the request and the results and filtering out results that do not meet a threshold similarity score. The module 114 may also rank results based on rating data, such as user-submitted reviews, so that items are ranked based on their rating when the volume of reviews meets a predefined threshold. In addition to or instead of static signals, the module 114 may also rank results based on dynamic popularity signals, such as recent purchase trends, social media mentions, or promotional engagement metrics. It should be understood that the foregoing approaches to ranking and/or filtering are merely examples and that others are contemplated and may be used in combination with each other, such as a ranking and/or filtering based on a composite index that combines different attributes so that the results are not only relevant to the request but also grounded in quality, popularity, and/or personalized relevance.

By centralizing data aggregation, the recommendation module 114 enables the AI-based application 122 to seamlessly integrate with multiple remote data sources without requiring direct integration and provide personalized, actionable, and up-to-date recommendations.

The data source interface 116 may be or include a structured communication layer that enables the intermediary device 104 to request and obtain (e.g., retrieve, receive) information from remote data sources, such as the remote data source 106. The interface 116 may include direct integrations with one or more remote data sources, which may also include data aggregators that may themselves have direct integrations with one or more remote data sources. The interface 116 may utilize APIs, web scraping, database queries, streaming protocols (e.g., WebSockets, Kafka), and/or the like, to communicate with the one or more remote data sources. The one or more remote data sources may be associated with particular categories of data so that the recommendation module 114 may use the interface 116 to automatically query particular remote data sources in response to a request that corresponds to a particular category of data. In some embodiments, the interface 116 supports data transformation so that disparate formats from different remote data sources (e.g., XML, JSON, CSV) can be normalized into a standard format before being provided to the recommendation module 114.

For example, when a smart assistant generates a recommendation for a travel destination, the recommendation module 114 may receive the recommendation, identify the travel destination (e.g., via named entity recognition and keyword extraction), and, in response to identifying keywords like “trip” and “Paris”, use the data source interface 116 to query an airline booking systems API for real-time flight availability to the destination, query a hotel booking systems API for real-time availability at the destination, and/or search the web via a search engine API for tourist attraction metadata relating to the destination. Similarly, when a smart assistant generates a recommendation for an item, the recommendation module 114 may receive the name of the recommended item and use the interface 116 to retrieve a predetermined set of data (e.g., item dimensions, stock availability, shipping estimates, and promotional discounts) for the recommended item and similar items (e.g., determined by the merchant) from multiple merchant APIs.

The remote data source 106 includes one or more computing devices configured to host one or more data sources. The remote data source 106 may be one or more physical and/or virtual servers and may include components described with respect to FIG. 6. The remote data source 106 may include structured digital records, which may be associated with one or more third parties. To receive and respond to requests, the remote data source 106 may integrate with the data source interface 116, for example, by obtaining and/or providing an API key to the data source interface 116. In response to a request, the remote data source 106 may provide digital records to the intermediary device 104 via the data source interface 116 for generating recommendations, retrieving real-time information, facilitating user interactions, and/or the like. In some embodiments, the digital records may include item-level and/or service-level data, which can be used to provide recommendations to the user on the AI-based application 122. In some embodiments, the digital records may include user-level data, such as account information, authentication information, transaction history, transaction capabilities, and/or the like. In some embodiments, the digital records provided to the intermediary device 104 may be cached and/or pre-loaded into the data repository 112 to reduce the number of queries to the remote data source 106.

In operation, the AI-based application 122 on the user device 102 may receive a query from a user (e.g., a prompt regarding the best running shoes for long-distance training) and generate a response (e.g., by a local and/or remote LLM) to the user based on the query. To make the response actionable, the application 122 may forward the response to the intermediary device 104 via the recommendation interface 124, and the intermediary device 104 may process the response using its recommendation module 114. The recommendation module 114 (via the data source interface 116) may query one or more local and/or remote data sources, such as remote data source 106, to retrieve information relating to the response, such as item details, user reviews, and/or similar items. The intermediary device 104 may refine the retrieved information by ranking and/or filtering the options, for example, based on dimensions, user ratings, relevance to the original request, user preferences, etc. The options may be returned to the user device 102 where they may be presented on the application 122. When the user clicks on a specific option, the user may be directed to interact with the corresponding remote data source via the user interface 126, which may be an embedded (e.g., native) interface, inline frame, or in-application web browser. This end-to-end workflow allows the AI-based application 122 to provide actionable recommendations without needing direct integration with remote data sources.

It should be understood that the use of the system 100 is not limited to the foregoing examples. In addition to the foregoing examples, it should be understood that system 100 can be used to intermediate interactions between a user device 102 and one or more remote data sources 106 for health care systems (e.g., interactions with electronic health record platforms), data management systems (e.g., interactions with cloud data platforms), order management systems (e.g., interactions with merchants), etc.

Not all of the depicted components shown in FIG. 1 may be used in all embodiments, and one or more embodiments may include additional, fewer, or different components than those shown in the figure. Variations in the arrangement and type of components may be made without departing from the spirit or scope of the claims as set forth herein. Furthermore, the modules described with respect to the system 100 are used for convenience to refer to functionality that the system 100 is configured to perform by way of one or more components of the system 100 (e.g., computer-readable instructions in memory).

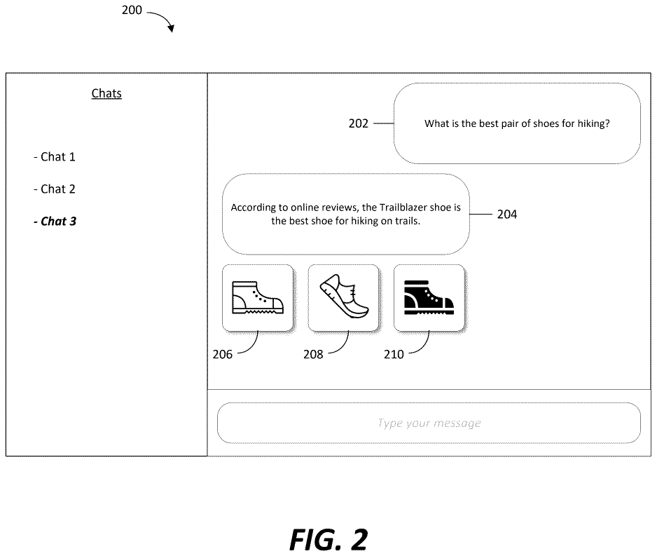

FIG. 2 is an example partial user interface 200 for an AI-based application 122, in accordance with one or more embodiments. In the example of FIG. 2, in the user interface 200, the user provides an input 202 to the AI-based application 122 asking, “What is the best pair of shoes for hiking?” The AI-based application 122, utilizing a local and/or remote LLM, generates an output 204, stating “According to online reviews, the Trailblazer shoe is the best shoe for hiking on trails.” Ordinarily, if the user wanted to view more information about the shoe, the user would leave the AI-based application 122 and manually search for the shoe (e.g., on a web browser via search engine) to determine where the shoe could be obtained, how others have reviewed the shoe, etc.

Instead of leaving the user with a static textual answer, however, the AI-based application 122 incorporates dynamic recommendations from one or more remote data sources obtained and/or curated by the intermediary device 104 into the output 204. Not only does this save the user from having to perform manual research, but it allows the user to take advantage of personalization that can be provided by the intermediary device 104, which may aggregate data from a variety of remote data sources and may collect history about the user's interactions across remote data sources. For example, if the intermediary device 104 is a computing action request processor, the user's purchase history may be a factor in determining which options to recommend and/or from which merchants. In addition, the intermediary device 104 as a computing action request processor may partner with certain merchants so that the intermediary device 104 can present special offers (e.g., priority interactions, discounts) to the user directly in the user interface 200.

To make the output 204 actionable, the AI-based application 122 may send a recommendation request to the intermediary device 104, which may utilize its data source interface 116 to retrieve data from one or more remote data sources 106, such as online merchants. The recommendation request may include the input 202 and/or the output 204, or portions (e.g., keywords) thereof. The recommendation module 114 may select the three most relevant shoe options 206, 208, 210, based on the recommendation request, each of which may be accompanied by an item image, item name, and a link to the corresponding remote data source where the user can view or request the item. The options 206, 208, 210 may be the shoe from the output 204 offered by various merchants and/or shoes that are commonly bought by others interested in the specified shoe. The options 206, 208, 210 may appear dynamically beneath the output 204, offering a dynamic, unified user experience.

Each option 206, 208, 210 may be embedded with an interactive (e.g., clickable) link that can open an in-application browser window, an inline frame, or native user interface, allowing the user to take immediate action (e.g., view item details, view items reviews, or save the item for later) without leaving the AI-based application 122. This end-to-end integration transforms a simple question into an interactive experience, all within the AI-based application 122 without having to integrate the AI-based application 122 to each remote data source.

The user interface 200 involves interacting with an AI-based application 122, which may be or include a smart assistant embodied as an LLM. It should be understood, however, that use of the user interface 200 of the AI-based application 122 for online transactions is merely an example and that other applications for the user interface 200 and the AI-based application 122 are possible.

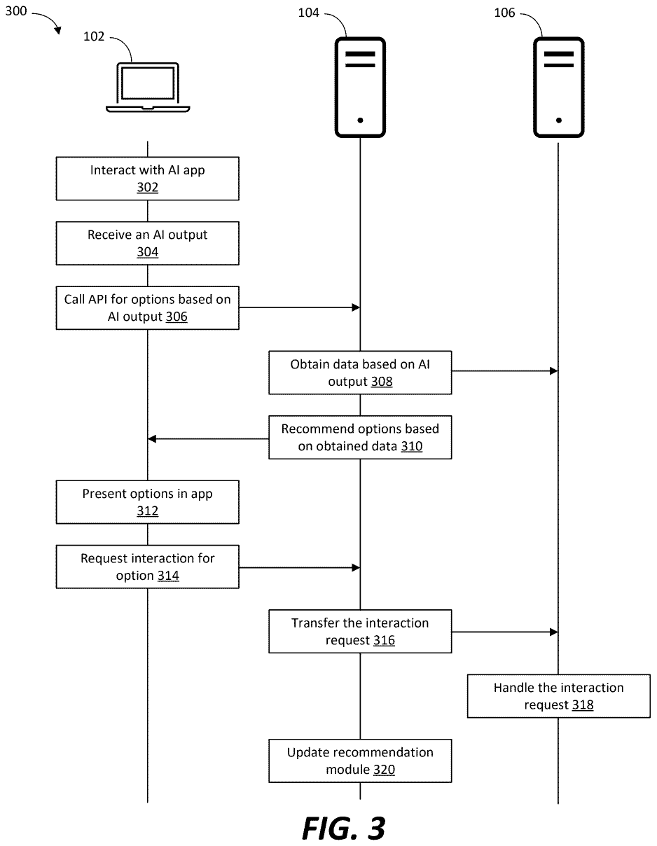

FIG. 3 is a process diagram of an example process 300 for intermediated interactions between two computing devices, in accordance with one or more embodiments. For explanatory purposes, the figure is described with reference to the system 100 of FIG. 1 and thus the process 300 may be a computer-implemented method. However, this is merely illustrative, and features of the system 100 may be performed by any other system for implementing the subject technology. Additionally, for explanatory purposes, the operations of the process 300 are described herein as occurring sequentially or linearly. However, multiple operations of the process 300 may occur in parallel. The operations of the process 300 need not be performed in the order shown, and one or more operations of the process 300 need not be performed or can be replaced by other operations.

The example process 300 involves intermediating interactions, which may be an online transaction between the user device 102 and remote data source 106. To intermediate an interaction includes managing the flow of data, requests, and/or responses without requiring the user device 102 to integrate directly with other data sources. In the context of an online transaction, this may include the intermediary device 104 receiving a structured request from the user device 102 (e.g., selecting an item or initiating a purchase), transforming and forwarding the request to the appropriate remote data source 106 (e.g., a merchant's API), handling any necessary authentication or formatting, and/or processing the response (e.g., confirming the transaction status or retrieving updated item details) before sending an update back to the user device 102. By handling the exchange, the intermediary device 104 abstracts the complexity of integrations with data sources, provides consistent security and data formatting, and enables the user to complete interactive experiences (e.g., shopping, booking, data management) within the AI-based application 122. It should be understood, however, that use of the system 100 for online transactions is merely an example and that other applications for the system 100 are possible.

The process 300 enables the intermediary device 104 to present a native interaction experience on the user device 102 and also enables the use of services offered by the intermediary device 104. For example, rather than relying on the potentially disparate checkout flows of each data source, the intermediary device 104 may be a computing action request processor that handles the transactions across a variety of remote data sources. The intermediary device 104 may also be an orchestrator that subsequently facilitates the fulfillment of the transactions with the relevant data source servers, which may include forwarding purchase details, confirming inventory allocation, initiating shipping processes, and/or handling digital delivery logistics. In this orchestration role, the intermediary device 104 may manage pipelines, data translation, and error handling across systems, enabling smooth transitions between transaction processing and fulfillment. The intermediary device 104 may also rank data sources, particularly when multiple sources are available for to fulfill a given product or service (e.g., choosing between merchants based on fulfillment speed, inventory availability, or delivery reliability) enabling the intermediary device 104 to optimize and facilitate both the recommendations provided to the user and the execution and delivery of the user's interactions.

At operation 302, an application 122 receives an interaction from a user via the user interface 126. The interaction may be a query, question, request, prompt, or any other suitable format, which may be in the form of text, voice, or any other input methods. The application 122 may use an LLM or other AI system to generate an output, such as an AI-generated content, prediction, or recommendation. For example, the application 122 may include a smart assistant chatbot that the user may engage with by asking, “What is a good business casual outfit for an office setting?” As another example, in a fashion styling app, the user could request an outfit recommendation tailored to their style preferences, past interactions, or an upcoming event.

At operation 304, the application 122 may process the request and generate an output (e.g., output 204). The application 122 may process the request with an AI model that analyzes contextual information, such as the user's preferences, past interactions, general knowledge embedded in the model's training data, and/or the like. The output may take various forms, such as text, images, audio, video, and/or any other suitable format depending on the type of AI model used and its intended purpose. For example, a chatbot might respond with text such as, “A great business casual outfit includes a tailored blazer, a neutral-colored blouse, and a pair of slim-fit trousers.” Meanwhile, a styling app may generate a visual outfit recommendation, curating a set of clothing items based on the user's personal style profile.

At operation 306, once the application 122 generates an output based on the interaction, the application 122 may send a request to the intermediary device 104, and the intermediary device 104 may receive the request, to retrieve additional information and enhance the output 204, for example, with options for items to purchase. The request may include the input 202 and/or the output 204, or portions (e.g., keywords) thereof.

For example, if application 122 has output a recommendation including “A tailored blazer, a neutral-colored blouse, and slim-fit trousers” as an ideal business casual outfit, the application 122 may generate and send a request to the intermediary device 104 with keywords and attributes extracted from the recommendation. The application 122 may tokenize the output, where the output is broken down into individual words or tokens, such as “A”, “tailored”, “blazer”, “a”, “neutral-colored”, “blouse”, “and”, “slim-fit”, and “trousers”. The application 122 may tag the tokens for parts of speech, where each token is assigned a part of speech such as noun, verb, adjective, or conjunction, allowing the application 122 to identify “blazer”, “blouse”, and “trousers” as nouns, and “tailored”, “neutral-colored”, and “slim-fit” as adjectives. The application can then use tokens and parts of speech tags to identify the keywords in the sentence and generate a query string, such as “tailored blazer” or “neutral-colored blouse”, to send as a request to the intermediary device 104, which can return relevant results based on the query string. The application 122 may also or instead use techniques such as named entity recognition to identify specific brands or categories, and dependency parsing to analyze the grammatical structure of the sentence, and/or machine learning algorithms to learn from user behavior and improve its ability to identify items over time.

Similarly, in a fashion styling application, if the AI-generated output includes a visual collage of a suggested outfit, the application may use object recognition or metadata tagging to extract relevant descriptors (e.g., “navy structured blazer,” “white silk blouse,” “gray slim-fit trousers”) for generating a request to the intermediary device 104. The request may also include parameters specifying preferred brands, budget constraints, geographic availability, or any other suitable parameters to further tailor the request.

At operation 308, after receiving the request from the AI-based application 122, the recommendation module 114 may retrieve data from local and/or remote data sources (e.g., remote data source 106 via data source interface 116) based at least in part on the request. The recommendation module 114 may analyze the incoming request, extracting parameters such as item categories, item attributes, user preferences, and contextual metadata, if the application 122 did not already do so for generating the request. For instance, if the AI-based application 122 output recommended and the request includes “A tailored blazer, a neutral-colored blouse, and slim-fit trousers”, the intermediary device 104 may break down these terms (e.g., via tokenization, part-of-speech tagging, named entity recognition, etc.) into structured query parameters such as type (blazer, blouse, trousers), style (tailored, neutral-colored, slim-fit), and other filters (size range, availability, brand preferences). These parameters may guide the querying of remote data sources 106 via the data source interface 116.

The data source interface 116 enables the intermediary device 104 to communicate with the remote data source 106 and/or other local and/or remote data sources (e.g., e-commerce platforms, manufacturer catalogs, fashion merchants, or item aggregators) for retrieving information relevant to the request. The data sources may include structured databases (e.g., SKU catalogs from online merchants), live APIs (e.g., brand-specific inventory systems), and/or other external content providers (e.g., fashion review aggregators or stock comparison tools). The intermediary device 104 may generate and send requests to one or more remote data sources 106, each of which may return a list of relevant options along with metadata such as sizing, stock availability, images, user ratings, shipping options, promotional discounts, and/or web addresses.

Generating a request to one or more remote data sources 106 may include parsing the contents of the request from the user device 102, which may include keywords or structured parameters derived from the input 202 and/or from the AI-generated output 204. The parsed contents may include item categories, attributes, or contexts, such as “black leather boots,” “formal evening wear,” or “nearby tailoring services.” The intermediary device 104 may interpret parsed contents within the context of known user information, such as stored preferences, previous selections, demographic profiles, or interaction history (e.g., stored in the data repository 112). This allows the intermediary device 104 to weigh and/or prioritize certain parameters over others based on how well they align with the user's known affinities, effectively tailoring the downstream query process to favor content that is more likely to be relevant or desirable.

With the parameters ready, the intermediary device 104 may then determine which remote data sources 106 to query. The intermediary device 104 may pull data source information to surface through a dynamic catalog of registered (e.g., onboarded with the intermediary device 104) and/or discoverable remote data sources. When a request is received from the AI-based application 122 (e.g., for running shoes or tickets to a nearby event), the intermediary device 104 may parse the request to extract parameters such as item category, user preferences (e.g., sustainability, price sensitivity), and contextual data (e.g., location, timing, or event type). The parameters may then be matched against the catalog of registered data sources, which maps each data source to specific content domains, item types, fulfillment capabilities, geographic availability, merchant category codes (MCCs), and/or the like. Each data source in the catalog may include metadata such as API endpoints, supported request schemas, authentication requirements, and categorization tags (e.g., “sustainable fashion,” “same-day delivery,” or “premium electronics”). For registered data sources, the intermediary device 104 may then directly route requests through pre-established integrations using APIs or standardized data exchange formats, retrieving data from the data source such as product listings, inventory, promotions, and transaction data.

Additionally, the intermediary device 104 may link to or query separate discovery networks, such as affiliate networks, data aggregators, or scraped content, to discover merchants not yet registered but relevant to the user's query. If users repeatedly shows interest in type of product or under-represented category in the catalog, the intermediary device 104 may flag this interest to register new merchants into its catalog. Registration may involve initiating partnerships with previously unregistered sources, or temporarily integrating third-party data from affiliate marketplaces or product feeds to test user demand before committing to full integration. If a data source does not include an MCC code or cannot be matched to a known merchant category, registration may also include classifying the source based on the context of the query and the content it returns. This way, the intermediary device 104 may evolve based on real-time user interest and interaction trends.

Once the appropriate remote data sources have been identified, the intermediary device 104 may generate outbound requests tailored to the expected format of each remote data source 106, such as in the form of API requests. The requests to the remote data sources 106 may incorporate the relevant parsed content from the request from the user device 102, which may be enriched with additional data (e.g., preferred brands, size ranges, or color filters) based on the user profile. The intermediary device 104 may include authentication credentials, such as API keys, OAuth tokens, or signed headers, depending on the integration requirements of the remote data source. The credentials allow the intermediary device 104 to securely access remote APIs and ensure compliance with rate limits, usage policies, and service-level agreements.

By mediating these requests in real-time, the intermediary device 104 not only simplifies the interaction between AI-based applications 122 and remote data sources 106 but also ensures that the results returned are relevant, current, and/or optimized for the specific user.

At operation 310, once the recommendation module 114 receives responses from the remote data sources 106, the recommendation module 114 may aggregate, filter, and/or rank the options to generate relevant recommended options for the user. Generating relevant recommended options may involve sorting the responses by relevance, ranking the response, prioritizing user preferences, and/or eliminating duplicate or low-quality listings.

For example, if multiple merchants provide the same tailored blazer, the recommendation module 114 may prioritize the item with the highest availability, best customer reviews, or fastest shipping options. The recommendation module 114 may also apply machine learning models to prioritize item options the user is most likely to engage with based on previous interactions and/or behavioral data. In some embodiments, the user may be associated with an account on the intermediary device 104, and the account may be associated with user preferences (e.g., size preference), previous user interactions with remote data sources (e.g., past transaction behavior), and/or any other suitable metadata for contextualizing queries to data sources and/or personalizing recommendations.

Once the recommended options are generated, the recommendation module 114 may format the options for return to the AI-based application 122. Each recommended option may include an item title, image, description, availability status, and/or a direct link to the online location where the user can complete a transaction or further explore the recommendation (e.g., on the remote data source's platform). For example, if an output from the AI-based application 122 mentioned a high-performance running shoe, the intermediary device 104 may return a list of three top-rated running shoes from online merchants, each option accompanied by a thumbnail image, size, customer rating, and a link to the item page.

At operation 312, once the user device 102 receives the recommended options from the intermediary device 104, the user device 102 presents the options within the application 122 (e.g., options 206, 208, 210). The AI-based application 122 enables the user to seamlessly explore the options without leaving the application 122 interface, making it easy to review, compare, and take action on the recommended options.

For example, in a fashion styling application, if the user originally requested an outfit recommendation for a business casual setting, the AI-generated output may suggest a tailored blazer, a neutral-colored blouse, and slim-fit trousers. The application 122 may display a predetermined number of options for each clothing item, sourced from different merchants through the recommendations from the intermediary device 104. Each option provided to the user may include an image, brand name, title, available sizes, and a rating score, along with a user interface element labeled “View & Purchase” or “More Details”. The user can browse these options within the application 122, compare details, and make an informed selection, each of which may be facilitated by the intermediary device 104.

At operation 314, the user device 102 may send, and the intermediary device 104 may receive, a request for an interaction with a particular option. The user initiates an interaction with a particular option through input within the user interface 126, where each option may be presented alongside one or more interactive elements, such as buttons, taps, or swipes, which correspond to specific interactions.

For instance, when the application 122 presents a list of recommended fashion items, each item may be clickable to initiate a transaction. Each item may also be associated with other interface elements such as a “View More” button for expanding the item into a dedicated page; an “Add to Cart” button for initiating a transaction; a “Save for Later” icon (e.g., a heart or bookmark symbol) to store the item in a wishlist; or an “Ask for Alternatives” option to re-query the system for similar items. The interface elements may be linked to event handlers within the application 122, so when the user taps one, the application 122 generates a new request to send to the intermediary device 104.

This request may include the identifier for the selected item, as well as the specific type of action being initiated. For example, selecting “View More” may trigger a request for expanded metadata from the intermediary device 104, while “Add to Cart” may trigger intermediary device 104 to invoke the order processing API of the remote data source 106.

At operation 316, the intermediary device 104 facilitates interactions with the remote data source 106 on behalf of the user device 102. Users can initiate various interactions on the in-application interface with respect to the selected recommended option, such as adding the outfit to a wishlist, adjusting size and color preferences, or checking store availability. These interactions may be communicated back to the intermediary device 104, which then facilitates the backend interactions with the remote data source 106.

When a user initiates an interaction with a particular option, the intermediary device 104 facilitates the interaction by interpreting the incoming request from the user device 102 and executing the appropriate backend operation with the relevant remote data source 106. This process may involve mapping the interaction to a particular API endpoint or transaction flow, using the identifier that was associated with the selected option.

Upon receiving the request from the user device 102, the intermediary device 104 may parse the identifier (e.g., a product ID, SKU, or remote catalog reference) and the interaction type (e.g., “add_to_cart”, “fetch_full_details”, “initiate_transaction”). These parameters may be used to determine which remote data source 106 the interaction is associated with (e.g., since the intermediary maintains mappings between identifiers and registered third-party providers) and which API endpoint or service to invoke in order to carry out the intended interaction.

For example, if a user taps “Add to Cart” on an item, the intermediary device 104 may recognize this as a transactional interaction and send a request to the cart management API of a merchant, passing along the identifier, user context (e.g., selected size or color), and session metadata. Similarly, if the interaction is “View More,” the intermediary device 104 may send a request to the content API of a merchant that returns product details, availability status, and additional media, which the intermediary device 104 may then forward to the user device 102 for rendering in the application 122. In a more complex case like “initiate_transaction”, the intermediary device 104 may trigger a multi-step process that begins with verifying real-time availability, reserving inventory, and forwarding the user to a payment flow.

In some embodiments, the intermediary device 104 may also be responsible for managing authentication and authorization when communicating with APIs of remote data sources 106. The requests from the intermediary device 104 to a remote data source 106 may include the API keys, tokens, or access credentials in the request headers for secure, authenticated access to the remote data source 106. Furthermore, the intermediary device 104 may handle rate limiting, retry logic, and error management.

In some embodiments, the intermediary device 104 may be or may be integrated with a computing action request processor. In which case, the intermediary device 104 may process the payment before passing the interaction (e.g., purchase) to the remote data source 106 for handling (e.g., fulfillment).

At operation 318, when a remote data source 106 receives a request from the intermediary device 104, the remote data source 106 processes the request based on the nature of the interaction. The nature of the interaction can range from item availability checks to delivery requests and order confirmations.

If the request is a purchase request, for example, the remote data source 106 initiates a sequence of backend processes to validate and execute the purchase. Once the payment is successfully processed, the remote data source 106 may create an order record, assign an order identifier, and initiate fulfillment procedures. Fulfillment procedures may include sending a confirmation email to the user, generating a shipping label, and updating the inventory system to reflect the sale.

If the request relates to checking the status of an item (e.g., to check the availability of a specific blazer in size medium), for example, the remote data source 106 may query its inventory database to retrieve the latest stock levels. If the item is available, the remote data source 106 may respond to the intermediary device 104 with updated details, such as “In Stock,” the number of remaining units, estimated shipping times, and potential discounts.

If the request relates to past orders (e.g., returns or exchanges), for example, the remote data source 106 may handle post-transaction processes. Post-transaction processes may include handling disputes, processing return shipping labels, or issuing refunds, and the remote data source 106 may update its records accordingly.

If the request is a booking request for a fitness class, for example, the remote data source 106 may initiate a backend process to verify the availability of the requested time slot and class type. Once the slot is confirmed, the remote data source 106 may assign a booking reference number, update the class roster, and send a confirmation notification to the user.

If the request is a reservation inquiry for a coworking space, for example, the remote data source 106 may check real-time room schedules and capacity constraints. If a room that fits the criteria is available, the remote data source 106 may return options along with details such as available time blocks, occupancy limits, amenities, and pricing.

If the request is a digital document access request (e.g., for retrieving a user's medical record or legal document), for example, the remote data source 106 may authenticate the request using the user's credentials, locate the appropriate document in a secure storage system, and generate a secure, time-limited access link.

At operation 320, the intermediary device 104 may update the recommendation module 114 based on the user's interactions with the recommended options. The recommendation module 114 may update metadata about the user's preferences, actions, and/or the like, refining future recommendations. For example, if the user consistently chooses earth-toned outfits and structured blazers over casual cardigans, the recommendation module 114 may prioritize similar recommendations in subsequent interactions.

Although foregoing discussion of the process 300 related to purchasing an item, it should be understood that other interactions with remote data sources are contemplated. Beyond purchase interactions, the user might also engage in other non-purchase interactions, such as saving the item to a wishlist, subscribing for restock notifications, or sharing the item link with a friend. Moreover, it should be understood that remote data sources are not limited to merchants and recommendations are not limited to items. For example, the remote data source 106 may be a health care provider that maintains electronic health records and recommendations from the intermediary device may include actions that can modify electronic health records related to the user.

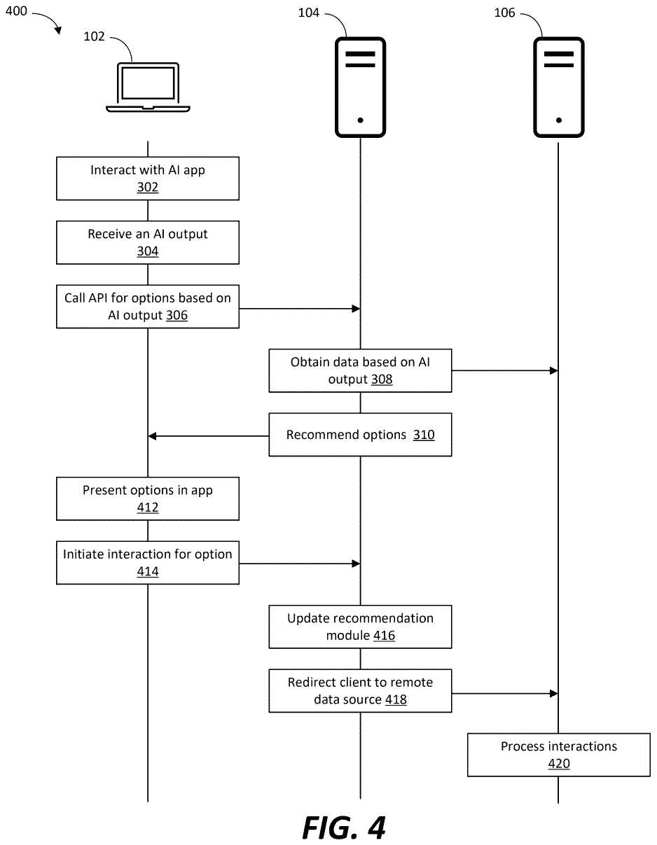

FIG. 4 is a process diagram of an example process 400 for intermediated interactions between two computing devices, in accordance with one or more embodiments. For explanatory purposes, the figure is described with reference to the system 100 of FIG. 1 and thus the process 400 may be a computer-implemented method. However, this is merely illustrative, and features of the system 100 may be performed by any other system for implementing the subject technology. Additionally, for explanatory purposes, the operations of the process 400 are described herein as occurring sequentially or linearly. However, multiple operations of the process 400 may occur in parallel. The operations of the process 400 need not be performed in the order shown, and one or more operations of the process 400 need not be performed or can be replaced by other operations.

While the intermediary device 104 may communicate with the remote data source 106 on behalf of the user device 102, other approaches for intermediating interactions by the intermediary device 104 are contemplated. For example, the process 400 describes an approach for intermediating interactions in which the intermediary device 104 redirects or routes the user device 102 directly to the remote data source 106.

At operation 414, when the user selects one of the recommended options, instead of changing to another application, the AI-based application 122 may open an in-application browser window, inline frame, and/or the like, where the user can directly interact with the platform associated with the remote data source. This way, the user may interact (e.g., browse, customize, purchase) with the option directly from the remote data source 106 while maintaining a unified in-application experience.

At operation 416, the recommendation module 114 in the intermediary device 104 receives a callback event indicating the user's selection. The callback event may be received from the user device 102 and/or the remote data source 106. The callback event allows the recommendation module 114 to, for example, update metadata about the user, improving the personalization of future suggestions. Additionally, the metadata update may enhance collaborative filtering models, allowing the recommendation module 114 to refine recommendations not only for the individual user but also for similar users with shared preferences.

At operation 418, the intermediary device 104 redirects the user device 102 to the remote data source 106 (e.g., merchant's website) so that the user device 102 may interact directly with the remote data source 106 inside the in-application browser. Displaying the page to the user allows the user to view item details, select sizes, read reviews, and/or complete a purchase directly with the remote data source, all while remaining within the environment of the application 122.

In some embodiments, the intermediary device 104 may embed tracking parameters, referral tags, cookies, and/or the like in the link presented to the user so that the intermediary device 104 can monitor user interactions (e.g., whether the user added the item to their cart, clicked on alternative options, or abandoned the page before completing the purchase) to improve the recommendation module 114.

At operation 420, once the intermediary device 104 redirects the user device 102 to the remote data source 106, the user can engage directly with the remote data source 106 to complete an interaction, such as purchasing the recommended fashion item, checking item details, or saving it for later. This transition provides a seamless user experience, allowing the user to move from an AI-generated recommendation to an interaction without leaving the ecosystem of the application 122.

For example, after receiving a personalized business casual outfit suggestion, the user selects a navy tailored blazer from one of the options recommended by the intermediary device 104. When an in-application browser loads the item page, the user can explore more details, such as fabric composition, size charts, customer reviews, and styling tips directly from the merchant. The user may decide to proceed with a purchase by selecting a size and adding the blazer to their cart, leveraging the merchant's existing checkout system, which may include payment methods, discount codes, and loyalty program benefits.

In some embodiments, once the interaction is completed, the remote data source 106 may send data back to the intermediary device 104 via mechanisms such as affiliate referral tracking or event callbacks. The data from the remote data source 106 may help the intermediary device 104 refine the recommendation module 114 by indicating whether a recommended option led to a successful conversion, allowing the system to improve future suggestions based on actual user behavior.

Although foregoing discussion of the process 400 related to purchasing an item, it should be understood that other interactions with remote data sources are contemplated. Beyond purchase interactions, the user might also engage in other non-purchase interactions, such as saving the item to a wishlist, subscribing for restock notifications, or sharing the item link with a friend. Moreover, it should be understood that remote data sources are not limited to merchants and recommendations are not limited to items. For example, the remote data source 106 may be a health care provider that maintains electronic health records and recommendations from the intermediary device may include actions that can modify electronic health records related to the user.

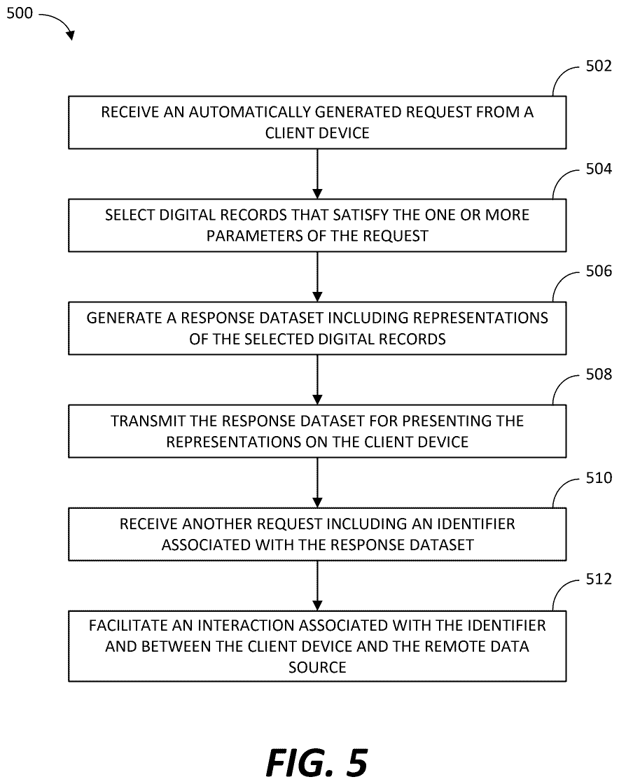

FIG. 5 is a flow diagram of an example process 500 for intermediating interactions between two computing devices, in accordance with one or more embodiments. For explanatory purposes, the figure is described with reference to the system 100 of FIG. 1 and thus the process 500 may be a computer-implemented method. However, this is merely illustrative, and features of the system 100 may be performed by any other system for implementing the subject technology. Additionally, for explanatory purposes, the operations of the process 500 are described herein as occurring sequentially or linearly. However, multiple operations of the process 500 may occur in parallel. The operations of the process 500 need not be performed in the order shown, and one or more operations of the process 500 need not be performed or can be replaced by other operations.

At operation 502, the intermediary device 104 receives a first request from the user device 102. The user device 102 may generate the first request based on and in response to output (e.g., output 204) from an AI model (e.g., an LLM, diffusion model).

For example, a user may prompt a fashion styling smart assistant application, “What should I wear to a winter wedding?” The AI model of the application may process the prompt and generate a textual response recommending “a formal wool coat, a velvet blazer, a satin midi dress, and suede ankle boots.” Additionally, if the AI model is multimodal, the AI model may generate an image of a complete winter wedding outfit, visually depicting the recommended ensemble. To make this recommendation actionable, the AI-based application 122 may automatically generate a request to the intermediary device 104 in response to providing the recommendation. The request may include at least part of the user input (e.g., input 202) and/or the AI-generated output (e.g., output 204) in the application 122. In some embodiments, the request may include relevant parameters extracted from the AI-generated output. For example, the AI-based application 122 may use tokenization, part-of-speech tagging, named entity recognition, and/or the like, to identify keywords included in the first request.

The first request includes one or more parameters, which may serve as search criteria for retrieving relevant items, services, information, and/or any other resource. The parameters may include text-based keywords, such as “wool coat,” “velvet blazer,” “satin midi dress,” and “suede ankle boots,” which may be mapped to relevant item categories in a database of the intermediary device 104. Additionally, if the AI model has generated an image, the parameters may also include visual metadata, such as object detection results, color schemes, or style attributes extracted from the generated image. Beyond descriptive parameters, the parameters may also include user preferences, historical data, and/or location data.

At operation 504, the intermediary device 104 selects one or more digital records that include predefined attributes satisfying the parameters of the first request. The intermediary device 104 may include a centralized data repository (e.g., data repository 112), which may be or include an aggregation layer for digital records from one or more remote data sources (e.g., remote data source 106), such as merchant platforms, brand catalogs, service aggregators, or content databases. The digital records may be structured datasets that may include predefined attributes, such as item categories, descriptions, stock levels, media files (e.g., images and videos), customer ratings, and purchasing options. At least some of the digital records in the centralized data repository may be stored locally, while others may be dynamically obtained from remote data sources (e.g., via the data source interface 116).

To select the most relevant digital records, the intermediary device 104 may compare the predefined attributes of available records with the parameters from the first request. Records having predefined attributes that match at least some of the parameters from the first request may be selected. For example, if the AI-based application 122 recommended a velvet blazer for a winter wedding, the intermediary device 104 may scan the centralized repository for fashion items labeled as blazers with fabric attributes matching “velvet” and event classification matching “formal” or “winter.” Additional filters, such as size range, availability, or brand preference, may also be applied based on constraints specified in the first request.

In some embodiments, the selection process may also be based on user affinity data to improve personalization. The intermediary device 104 may maintain user affinity data within its centralized data repository 112. User affinity data may be based on past interactions that the intermediary device 104 has overseen and/or preconfigured preferences associated with an account of the user. User affinity data may include user preferences (e.g., favorite brands, preferred color schemes, or favored styles), previous selections (e.g., past purchases, saved items, or frequently viewed items), behavioral signals (e.g., interaction history within the AI-based application 122, click-through rates, or past rejection of similar recommendations), geographic preferences (e.g., relevant regional merchants or items that ship to the user's region).

At operation 506, once the intermediary device 104 selects the digital records, the intermediary device 104 generates a response dataset to send to the user device 102 in response to the first request. The response dataset may include structured output (e.g., from the recommendation module 114) that allows the AI-based application 122 to generate a user interface where the user can interact with the digital records.

The response dataset may include identifiers for each digital record, which may allow the user device 102 and/or intermediary device 104 to track, retrieve, and/or take action on the digital records. For example, if the selected digital records include fashion items from different merchants, each item entry in the dataset may include a SKU (stock keeping unit) code, item ID, or API reference key that can be used to retrieve additional details. By including the identifiers, the intermediary device 104 enables the AI-based application 122 to maintain accurate references to external content without storing or managing the full dataset locally.

In addition to identifiers, the metadata in the response dataset may include textual and/or visual content that enhances the presentation of the selected digital records. Text-based metadata may include, for example, item names, descriptions, material details, availability status, customer ratings, and promotional offers. Visual-based metadata may include thumbnails, high-resolution image links, or alternate views of the selected item.

At operation 508, the intermediary device 104 transmits the response dataset to the user device 102 for presenting at least some of the metadata of the digital records to the user via an interactive user interface. The structured format of the response dataset allows the AI-based application 122 to generate visual elements based on the digital records so that users can explore recommendations, compare options, and take action within the user interface of the application 122. This enables the dynamic integration of AI-generated output with actionable content, which saves users from manually searching for the recommended items or services.

At operation 510, the intermediary device 104 receives a second request from the user device 102. The second request may be generated automatically by the application 122, capturing the user's selection and conveying the selection to the intermediary device 104 for further action. Unlike the first request, which was generated based on an AI-generated recommendation, the second request may be generated based on user input.

The second request may include at least one identifier associated with the selected digital record, which may have originally been provided to the user device 102 in the response dataset from the intermediary device 104. For example, if the user selects a luxury velvet blazer from a list of AI-enhanced fashion recommendations, the application 122 generates the second request including the item identifier (e.g., SKU: 12345, item ID: ABCD 789), which may correspond to a digital record stored in the centralized data repository of the intermediary device 104.

The second request may also include metadata representing the user's specific interaction with the selected item. For instance, if the item is available in multiple sizes or colors, the second request may include additional attributes such as size (“Medium”), color (“Navy Blue”), and preferred merchant (“BrandX Official Store”). In cases where the AI-based application 122 supports customization features, the second request may also include style modifications, bundling options, or any applied discount codes selected by the user before submission.

At operations 512, in response to the second request, the intermediary device 104 facilitates an interaction between the user device 102 and a remote data source 106. The nature of the interaction may depend on the identifier or other metadata included in the second request and may involve placing an order, reserving an item, modifying user preferences, or verifying the status of a selected record. To carry out the interaction, the intermediary device 104 may generate and transmit a request to the remote data source 106.

The remote data source 106 may process the request, executing the corresponding actions in its system. If the request involves a purchase, for example, the remote data source 106 may verify item availability, payment authorization, and/or order processing workflow. If the request relates to a reservation or service booking, for example, the remote data source 106 may update its availability records, assign a booking reference, and/or confirm the reservation in its digital records. The remote data source 106 may return the outcome of the processing to the intermediary device 104 in the form of a response including a status parameter, which may indicate whether the interaction was successful, partially successful, or failed.

Upon receiving the response from the remote data source 106, the intermediary device 104 may interpret the status parameter and determine the appropriate next steps. A successful interaction may be indicated by a status such as “Order Confirmed,” “Booking Successful,” or “Item Reserved”, which may be accompanied by a confirmation number, tracking details, or further instructions for the user. If the interaction encounters an issue (e.g., “Item Out of Stock,” “Payment Declined,” or “Time Slot Unavailable”), the response may include an error code and suggested alternatives, such as a list of related items, alternative sizes, or available booking times.

Based on the received status, the intermediary device 104 may prepare a response to the user device so that the AI-based application 122 may display a message that corresponds to the status parameter. If the purchase is confirmed, for example, the application 122 may present an order confirmation screen with an estimated delivery date. If the booking was successful, for example, the application 122 may update the user's appointment schedule with relevant details. In cases where the request failed, the AI-based application 122 may prompt the user with alternative selections or retry options so that the user can continue interacting with remote data sources without interruption.

In some embodiments, generating the second request involves the user device 102 displaying embedded content that is hosted by the intermediary device 104. For example, if a user selects a recommended luxury handbag, instead of immediately sending a transaction request to a merchant, the application 122 may display an intermediary-hosted item detail page within the application 122. The embedded content may include, for example, additional item images, detailed descriptions, promotional offers, and dynamic stock availability updates. This way, the intermediary device 104 can aggregate and standardize data from multiple sources before sending the second request, which enables the user to see a consistent presentation of digital records. If the item is available from multiple merchants, the intermediary device 104 may host a comparative availability display, enabling the user to select the preferred vendor before generating the second request.

In some embodiments, facilitating the interaction between the user device 102 and the remote data source 106 may include redirecting an in-application browser or inline frame (iframe) on the user device 102 to an external online address associated with the remote data source 106. This may occur when the intermediary device 104 does not have API access to directly complete the transaction or when the remote data source 106 requires users to complete additional steps, such as authentication or payment authorization, within the environment hosted by the remote data source 106. For example, if the user is purchasing a ticket for an event, the ticketing provider may require the user to complete identity verification on the environment hosted by the ticketing provider. Once the user completes the interaction on the remote platform, the remote data source 106 can notify the intermediary device 104 of the interaction, which can then be reflected back in the AI-based application 122.

In some embodiments, facilitating the interaction between the user device 102 and the remote data source 106 includes modifying account information associated with the user device and stored on the centralized data repository of the intermediary device 104. When facilitating interactions between the user device 102 and a remote data source 106, the intermediary device 104 may modify account information stored in its centralized repository to enhance personalization. If the intermediary device 104 is part of a computing action request processor, it can update preferred payment methods, billing addresses, or shipping preferences based on the user's transaction history.

In some embodiments, facilitating the interaction between the user device 102 and the remote data source 106 includes modifying user affinity data for subsequent selecting and filtering of digital records. For example, if a user frequently selects dark-colored business attire and sustainable brands, the intermediary device 104 may record these preferences so that future outfit recommendations prioritize similar styles. Conversely, if the user rejects floral patterns or synthetic fabrics, the intermediary device 104 may record these preferences so that they are deprioritized in future recommendations.

FIG. 6 is a block diagram of an example computing device 600. A computing device 600 may be a desktop computer, laptop, smartphone, tablet, or any other electronic device having the ability to execute instructions, such as those stored within a non-transitory computer-readable medium. Furthermore, while described and illustrated in the context of a single computing device 600, those skilled in the art will also appreciate that the various tasks described hereinafter may be practiced in a distributed environment having multiple computing devices 600 linked via a local-or wide-area network in which the executable instructions may be associated with and/or executed by one or more of multiple computing devices 600.

In its most basic configuration, the computing device 600 may include at least one processing unit 602 and at least one memory 604, which may be linked via a bus 606. Depending on the exact configuration and type of computing device environment, memory 604 may be volatile (such as RAM 610), non-volatile (such as ROM 608, flash memory, etc.) or some combination of the two.

Computing device 600 may have additional features and/or functionality. For example, computing device 600 may also include additional storage (removable and/or non-removable) including, but not limited to, magnetic or optical disks, tape drives and/or flash drives. Such additional memory devices may be made accessible to the computing device 600 by means of, for example, a hard disk drive interface 612, a magnetic disk drive interface 614, and/or an optical disk drive interface 616. As will be understood, these devices, which may be linked to the system bus 606, respectively, allow for reading from and writing to a hard drive 618, reading from or writing to a removable magnetic disk 620, and/or for reading from or writing to a removable optical disk 622, such as a CD/DVD ROM or other optical media. The drive interfaces and their associated computer-readable media may allow for the non-volatile storage of computer-readable instructions, data structures, program modules and other data for the computing device 600. Those skilled in the art will further appreciate that other types of computer-readable media that can store data may be used for this same purpose. Examples of such media devices include solid-state drives, hard disk drives, flash drives, memory cards, random access memories, read-only memories, cloud-integrated storage modules, other read/write and/or read-only memories and/or any other method or technology for storage of information such as computer-readable (e.g., computer-implemented) instructions, data structures, program modules or other data. Any such computer storage media may be part of computing device 600.

A number of program modules may be stored in one or more of the memory/media devices. For example, a basic input/output system (BIOS 624), containing the basic routines that help to transfer information between elements within the computing device 600, such as during start-up, may be stored in ROM 608. Similarly, RAM 610, hard drive 618, and/or peripheral memory devices may be used to store computer-executable instructions comprising an operating system 626, one or more applications programs 628, other program modules 630, and/or program data 632. Still further, computer-executable instructions may be downloaded to the computing device 600 as needed, for example, via a network connection. The applications programs 628 may include, for example, recommendation module 114, data source interface 116, AI-based application 122, recommendation interface 124, and user interface 126. Accordingly, in some embodiments, the techniques described herein may be embodied in computer-executable instructions implemented as software, including as application software, system software, firmware, middleware, embedded code, or any other suitable type of software. Such computer-executable instructions may be written using any of a number of suitable programming languages and/or programming or scripting tools, and also may be compiled as executable machine language code or intermediate code that is executed on a framework or virtual machine.

An end-user may enter commands and information into the computing device 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processing unit 602 via interfaces such as, for example, a parallel port, game port, firewire, or a universal serial bus (USB). To view information from the computing device 600, a monitor 640 or other type of display device may also be connected to bus 606 via an interface, such as via video adapter 642. In addition to the monitor 640, the computing device 600 may also include other peripheral output devices, not shown, such as speakers and printers.

The computing device 600 may also utilize logical connections to one or more computing device environments. Communications between the computing device 600 and the remote computing device environment may be exchanged via a further processing device, such as a network router 641, that is responsible for network routing. Communications with the network router 641 may be performed via a network interface component 644. Thus, within such a networked environment, e.g., the Internet, wide area network (WAN), local area network (LAN), or other like type of wired or wireless network, it will be appreciated that program modules depicted relative to the computing device 600, or portions thereof, may be stored in the memory storage device(s) of the computing device 600.

The computing device 600 may also include localization hardware 646 for determining a location of the computing device 600. In embodiments, the localization hardware 646 may include, for example, a GPS antenna, an RFID chip or reader, a Wi-Fi antenna, or other computing hardware that may be used to capture or transmit signals that may be used to determine the location of the computing device 600.

While this disclosure has described certain embodiments, it is understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, the subject technology is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the subject technology.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A method comprising:
receiving, by an intermediary device, a first request from a user device, wherein the first request includes one or more parameters;
selecting, by the intermediary device, one or more digital records that include predefined attributes satisfying the one or more parameters, wherein the intermediary device comprises a centralized data repository that maintains digital records, at least some of the digital records are from remote data sources;
generating, by the intermediary device, a response dataset including metadata of the one or more digital records, the metadata including identifiers for referencing the one or more digital records;
transmitting, by the intermediary device and to the user device, the response dataset for presenting the metadata of the one or more digital records on the user device;
receiving, by the intermediary device and from the user device, a second request including at least one identifier associated with the response dataset, wherein the second request is generated in response to selection of the at least one identifier; and
facilitating, by the intermediary device in response to the second request, an interaction between the user device and a remote data source from the remote data sources, the interaction relating to the at least one identifier.

2. The method of claim 1, wherein facilitating the interaction between the user device and the remote data source comprises:
identifying, by the intermediary device, the remote data source from the digital records based on the at least one identifier;
transmitting, by the intermediary device and to the remote data source, a third request to modify a digital record on the remote data source, wherein the third request is generated based on the interaction and the at least one identifier;
receiving, by the intermediary device, a response from the remote data source, the response indicating at least one status parameter associated with the interaction; and
transmitting, by the intermediary device, the response to the user device for the user device to display a message corresponding to the at least one status parameter.

3. The method of claim 1, wherein facilitating the interaction between the user device and the remote data source comprises redirecting the user device to an online address associated with the remote data source.

4. The method of claim 1, wherein the centralized data repository maintains account information include an account associated with the user device, and facilitating the interaction between the user device and the remote data source comprises modifying the account associated with the user device based on the interaction.

5. The method of claim 1, wherein the intermediary device causes the user device to display a inline frame for facilitating the interaction with the remote data source.

6. The method of claim 1, wherein the first request is automatically generated based on content output from an artificial intelligence model.

7. The method of claim 1, wherein the centralized data repository maintains user affinity data, and selecting the one or more digital records is based on the user affinity data associated with the user device.

8. The method of claim 7, wherein the interaction facilitated by the intermediary device causes modification of the user affinity data for subsequent selecting of digital records from the centralized data repository.

9. The method of claim 1, wherein the one or more parameters of the first request includes any one or more of keywords or images.

10. The method of claim 1, wherein the metadata of the one or more digital records includes any one or more of text or images.

11. An electronic device comprising:
a processor; and
a non-transitory computer-readable medium storing instructions that, when executed by the processor, cause the electronic device to perform operations comprising:
selecting one or more digital records from a centralized data repository of digital records, wherein at least some of the digital records are from remote data sources, the one or more digital records include predefined attributes that satisfy one or more parameters, the one or more parameters are included in a first request from a user device, and the first request was automatically generated based on content output from an artificial intelligence model;
providing, in response to the first request, a response dataset to the user device for presenting representations of the one or more digital records on the user device, wherein the representations include identifiers for referencing the one or more digital records; and
intermediating an interaction between the user device and a remote data source from the remote data sources, wherein the interaction is based on a selected identifier, the selected identifier is included in a second request from the user device.

12. The electronic device of claim 11, wherein intermediating the interaction between the user device and the remote data source comprises:
requesting a modification to a digital record on the remote data source, wherein the modification is based on the interaction and the selected identifier; and
redirecting a response from the remote data source to the user device, wherein the response includes at least one status parameter associated with the interaction, and the response causes the user device to display a message corresponding to the at least one status parameter.

13. The electronic device of claim 11, wherein intermediating the interaction between the user device and the remote data source comprises:
identifying, from the centralized data repository, an online address associated with the remote data source; and
transmitting the online address to the user device.

14. The electronic device of claim 11, wherein intermediating the interaction between the user device and the remote data source comprises causing the user device to display embedded content hosted by the electronic device for receiving information associated with the interaction to provide to the remote data source.

15. The electronic device of claim 11, wherein intermediating the interaction between the user device and the remote data source comprises modifying account information associated with the user device and stored on the centralized data repository.

16. The electronic device of claim 11, wherein the one or more digital records are selected based on any one or more of user preferences or historical selections associated with the user device.

17. The electronic device of claim 11, wherein the one or more parameters of the first request includes any one or more of keywords or images, and wherein the representations of the one or more digital records includes any one or more of text or images.

18. A non-transitory computer-readable medium storing instructions that, when executed by a processor of an electronic device, cause the electronic device to perform operations comprising:
intermediating an interaction between a user device and a remote data source, wherein:
the interaction is based on an identifier provided by the user device,
the identifier is from a response dataset for presenting representations of one or more digital records on the user device,
the response dataset is provided to the user device in response to a second request from the user device for one or more digital records,
the representations include identifiers for referencing the one or more digital records,
the one or more digital records are selected from a centralized data repository of digital records,
at least some of the digital records are from remote data sources,
the one or more digital records include predefined attributes that satisfy one or more parameters,
the one or more parameters are included in a first request from the user device, and
the first request was automatically generated by the user device.

19. The non-transitory computer-readable medium of claim 18, wherein intermediating the interaction between the user device and the remote data source comprises causing the user device to display embedded content hosted by the electronic device for receiving information associated with the interaction to provide to the remote data source.

20. The non-transitory computer-readable medium of claim 18, wherein intermediating the interaction between the user device and the remote data source comprises:
causing the user device to display a inline frame for receiving information associated with the interaction to provide to the remote data source;
modifying account information associated with the user device, stored on the centralized data repository, and based on the information associated with the interaction;
requesting a modification to a digital record on the remote data source, wherein the modification is based on the interaction and the identifier; and
redirecting a response from the remote data source to the user device for presentation via the inline frame, wherein the response includes at least one status parameter associated with the interaction.
